(19) United States
(12) Patent Application Publication
(10) Pub. No.: US 2023/0414422 A1
(43) Pub. Date: Dec. 28, 2023

(54) Wheelchair Handle

(71) Applicant: Donna Davis-Nunes, LITHONIA, GA (US)

(72) Inventor: Donna Davis-Nunes, LITHONIA, GA (US)

(21) Appl. No.: 17/851,585

(22) Filed: Jun. 28, 2022

(51) Int. Cl. A61G 5/10

(52) U.S. Cl. CPC A61G 5/1051; A61G 2203/70

(57) ABSTRACT

The present invention is a wheelchair handle system we are by a pivot bracket supports an adjustable handle and the pivot bracket is configured to be attached and secured to an existing wheelchair arm.

### BACKGROUND OF THE INVENTION

The wheelchair is an incredible assistive device that has changed the lives of many persons experiencing mobility issues. Technology has greatly advanced both mechanical and motor assisted wheelchairs. Still, a very significant number of manual wheelchairs are in use around the world. There is one significant problem yet to be addressed. Very often, a person assisting a wheelchair-bound person has difficulty maneuvering the chair with the handles associated there with. This could be for a number of reasons. However, one significant drawback is that wheelchair handles are not adjustable.

The present invention addresses this need.

### SUMMARY OF THE INVENTION

As generally understood and describes herein, the present invention provides a system for use with an existing wheelchair. Typically, wheelchairs are pushed by a user whereby the user standing behind the wheelchair grabs the two wheelchair arms that extend backwards from the person sitting in the wheelchair. Very often, these wheelchair arms do have handle grips to assist in the pushing of the wheelchair.

In one embodiment the present invention is a wheelchair handle system comprising:
a pivot bracket constructed and arranged for securing onto an existing wheelchair arm;
an adjustable handle, said handle selectively lockable into a position vertical and perpendicular to or horizontal and parallel to said existing wheelchair arm; and
a clamp base configured to clamp and secure said pivot bracket onto said existing wheelchair arm.

In one embodiment the adjustable handle is associated with a locking pin.

In one embodiment the adjustable handle is associated with a locking pin to secure said adjustable handle into a position vertical and perpendicular to said existing wheelchair arm.

In one embodiment the adjustable handle is associated with a locking pin to secure said adjustable handle into a position horizontal and parallel to said existing wheelchair arm.

In one embodiment the clamp base configured to clamp and secure said pivot bracket onto said existing wheelchair arm is secured utilizing fastening bolts.

In one embodiment the adjustable handle is adjustable by removing and repositioning a shoulder bolt.

In one embodiment the present invention is a wheelchair handle system consisting of:
a pivot bracket constructed and arranged for securing onto an existing wheelchair arm;
an adjustable handle, said handle selectively lockable into a position vertical and perpendicular to or horizontal and parallel to said existing wheelchair arm;
a clamp base configured to clamp and secure said pivot bracket onto said existing wheelchair arm;
whereby the adjustable handle is associated with a locking pin and the adjustable handle is associated with a locking pin to selectively secure said adjustable handle into a position either vertical and perpendicular to said existing wheelchair arm or horizontal and parallel to said existing wheelchair arm and the clamp base is configured to clamp and secure said pivot bracket onto said existing wheelchair arm is secured utilizing fastening bolts, the adjustable handle is adjustable by removing and repositioning a shoulder bolt.

### BRIEF DESCRIPTION OF THE SEVERAL VIEWS OF THE DRAWINGS

FIG. 1 shows the invention in an environment of use.

FIG. 2 is a side view demonstrating attachment and pivot of the present invention.

FIG. 3 is a side view demonstrating the present invention with a handle pivoted into a position for use.

FIG. 4 is an end view of the present invention.

FIG. 5 is a side view of the handle of the present invention.

FIG. 6 is an end view of the handle of the present invention.

FIG. 7 is a side view of the pivot bracket according to the present invention.

FIG. 8 is an end view of the pivot bracket according to the present invention.

FIG. 9 is a side view of the clamp base according to the present invention.

FIG. 10 is an end view of the clamp base according to the present invention.

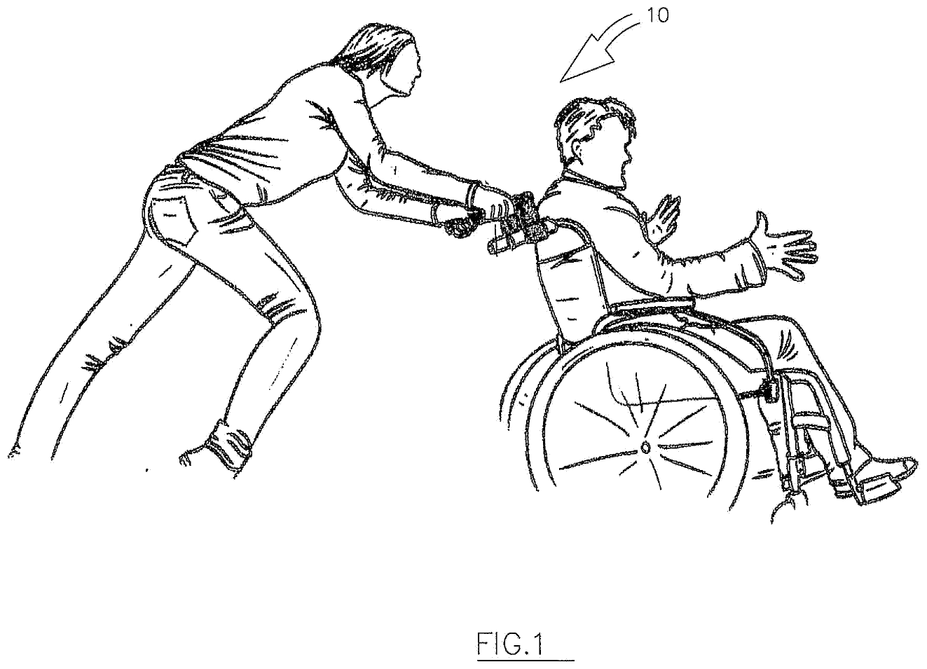

### DETAILED DESCRIPTION OF THE PREFERRED EMBODIMENTS

As demonstrated by the drawings accompanying, the present invention provides for a wheelchair handle system that is attached and removable on a conventional wheelchair.

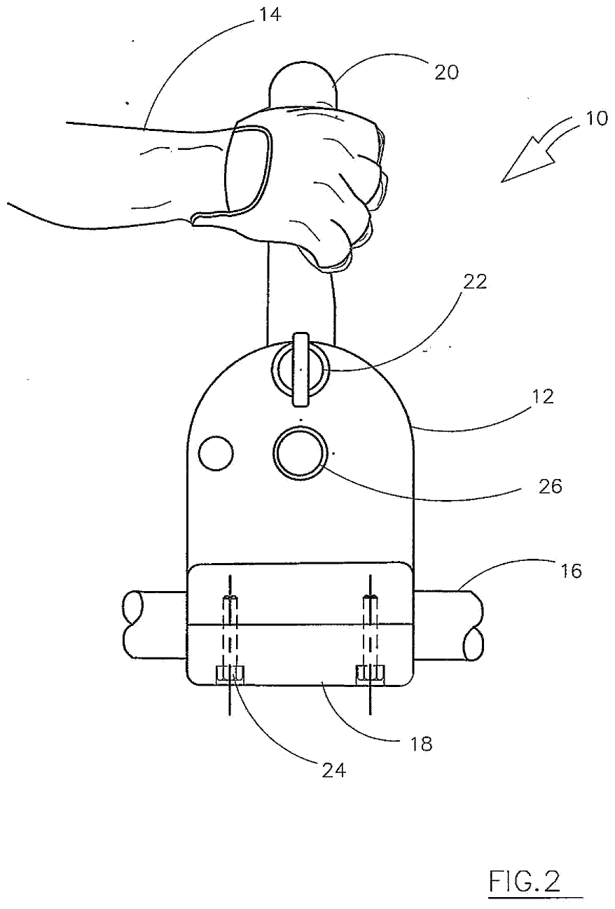

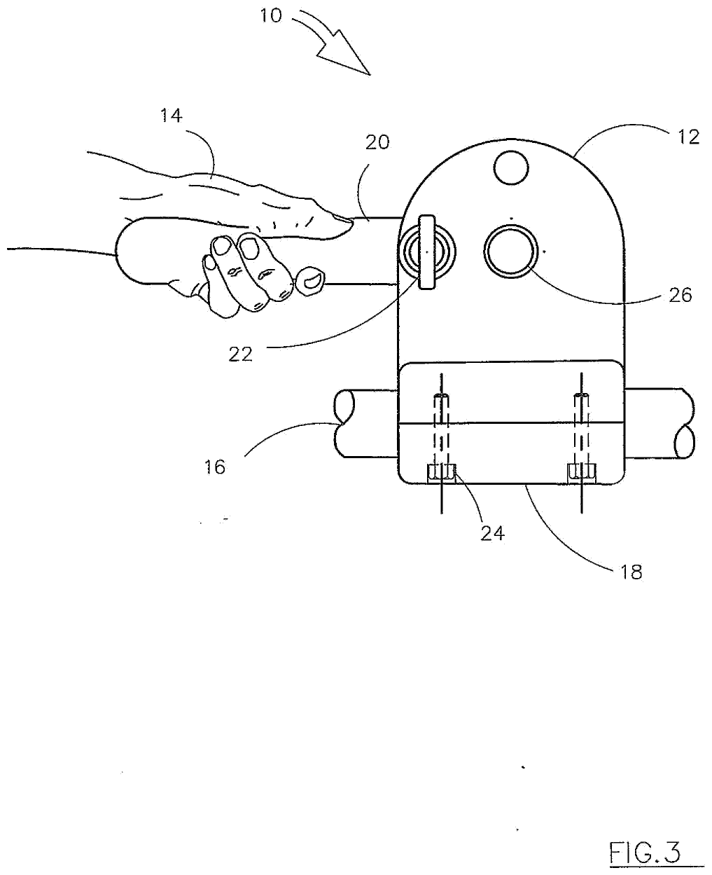

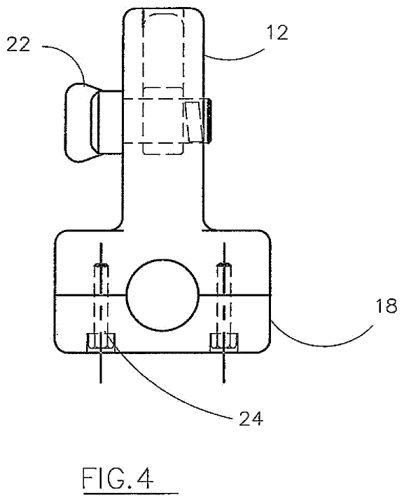

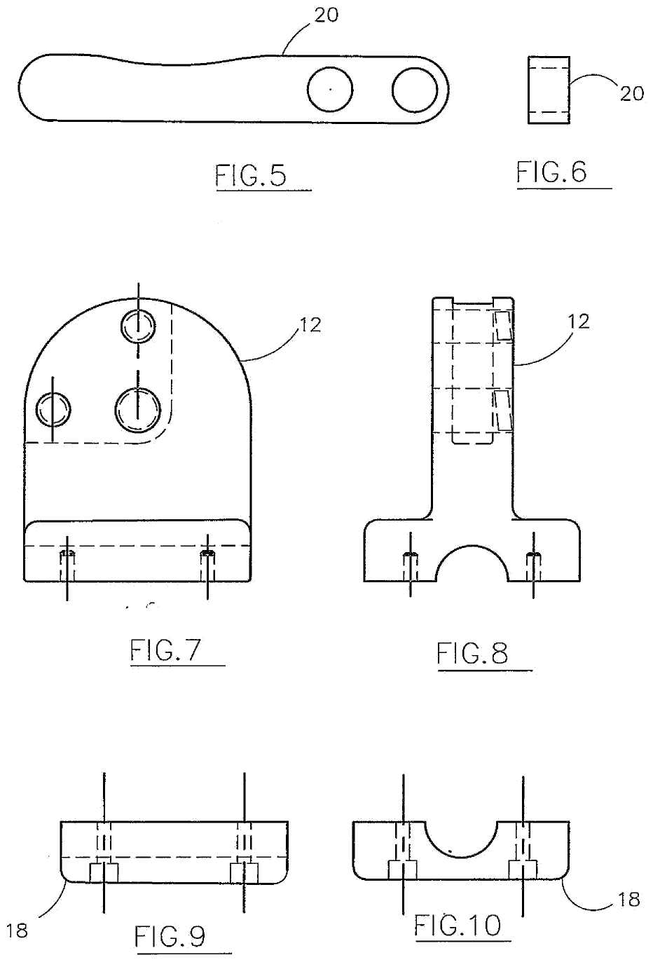

System 10 includes a pivot bracket 12 having adjustable handle 20 associated there with. Handle 20 rotates about shoulder bolt 26 and is locked into place by locking pin 22. Pivot bracket 12 is constructed and arranged to be secured onto an existing wheelchair arm 16. Pivot bracket 12 for the comprises clamp base 18. As generally understood by the figures, adjustable handle 20 is on a first side of pivot bracket 12 and clamp base 18 is on a second side of pivot bracket 12. Fastening bolts 24 are constructed and arranged to secure pivot bracket 12 onto existing wheelchair arm 16. As demonstrated in FIG. 2 and three, adjustable handle 20 is lockable in a vertical position, substantially perpendicular to existing wheelchair arm 16, and rotatably positionable, as in FIG. 3, into a horizontal position, substantially parallel to existing wheelchair arm 16. Pivot bracket 12 further includes shoulder bolt 26 which provides a pivotable axis and adjustable handle 20 is pivoted into a desired vertical or horizontal position. It is generally understood and demonstrated by the figures, a person 14 who is pushing a wheelchair in which the system of the present invention is attached has the option of positioning adjustable handle 20 and either a vertical or horizontal position. A user will remove locking pin 22, position handle 10 as desired by rotating handle bout shoulder bolt 26 then replace locking pin 22 once handle 20 is in position.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A wheelchair handle system comprising:
a pivot bracket constructed and arranged for securing onto an existing wheelchair arm;
an adjustable handle, said handle selectively lockable into a position vertical and perpendicular to or horizontal and parallel to said existing wheelchair arm; and
a clamp base configured to clamp and secure said pivot bracket onto said existing wheelchair arm.

2. The system of claim 1, wherein said adjustable handle is associated with a locking pin.

3. The system of claim 1, wherein said adjustable handle is associated with a locking pin to secure said adjustable handle into a position vertical and perpendicular to said existing wheelchair arm.

4. The system of claim 1, wherein said adjustable handle is associated with a locking pin to secure said adjustable handle into a position horizontal and parallel to said existing wheelchair arm.

5. The system of claim 1, wherein said clamp base configured to clamp and secure said pivot bracket onto said existing wheelchair arm is secured utilizing fastening bolts.

6. The system of claim 1, wherein said adjustable handle is adjustable by removing and repositioning a shoulder bolt.
